(19) United States
(12) Patent Application Publication
(10) Pub. No.: US 2026/0016113 A1
(43) Pub. Date: Jan. 15, 2026

(54) WRAPPED EXHAUST INSULATION SYSTEM AND METHOD

(71) Applicant: Lincoln Industries, Inc., Lincoln, NE (US)

(72) Inventors: Adam James Matzner, Lincoln, NE (US); John Michael Jarecki, Lincoln, NE (US)

(21) Appl. No.: 19/250,786

(22) Filed: Jun. 26, 2025

Related U.S. Application Data
(60) Provisional application No. 63/671,435, filed on Jul. 15, 2024.

(51) Int. Cl. F16L 59/10; F01N 13/14; F16L 59/02

(52) U.S. Cl. CPC F16L 59/10; F01N 13/14; F16L 59/026

(57) ABSTRACT

Exhaust insulation systems and methods are described that include a base insulation layer disposed about a section of a workpiece such as an exhaust pipe. Exhaust insulation systems and methods are described that further include an uncured elastomer tape wrapped over the base insulation layer. Exhaust insulation systems and methods are described that further include a cured continuous outer elastomer layer.

### CROSS-REFERENCE TO RELATED APPLICATIONS

This patent application claims the benefit of U.S. Provisional Patent Application No. 63/671,435, filed Jul. 15, 2024, entitled “WRAPPED EXHAUST INSULATION SYSTEM AND METHOD”, which is incorporated by reference herein in its entirety.

### TECHNICAL FIELD

Various embodiments described herein relate to insulation systems. One specific example includes exhaust pipe insulation systems.

### BACKGROUND

Insulation systems can be used to retain heat or cold within an enclosure. Insulation systems can also be used for safety to protect users from a hot region of equipment. In selected insulation systems, multiple material layers are used, wherein each layer serves a different purpose. Improved exhaust insulation systems are desired.

### BRIEF DESCRIPTION OF THE DRAWINGS

FIG. 1A shows an exhaust insulation system in a stage of manufacture according to an example of the present disclosure.

FIG. 1B shows an exhaust insulation system in another stage of manufacture according to an example of the present disclosure.

FIG. 1C shows an exhaust insulation system in another stage of manufacture according to an example of the present disclosure.

FIG. 1D shows an exhaust insulation system in another stage of manufacture according to an example of the present disclosure.

FIG. 1E shows an exhaust insulation system in another stage of manufacture according to an example of the present disclosure.

FIG. 2A shows an exhaust insulation system in a stage of manufacture according to an example of the present disclosure.

FIG. 2B shows an exhaust insulation system in another stage of manufacture according to an example of the present disclosure.

FIG. 3A shows an uncured elastomer tape in a stage of manufacture according to an example of the present disclosure.

FIG. 3B shows an elastomer tape in a stage of curing according to an example of the present disclosure.

FIG. 3C shows an elastomer tape in a stage of curing according to an example of the present disclosure.

FIG. 3D shows an elastomer tape in a stage of curing according to an example of the present disclosure.

FIG. 4A shows an uncured elastomer tape in a stage of manufacture according to an example of the present disclosure.

FIG. 4B shows an elastomer tape in a stage of curing according to an example of the present disclosure.

FIG. 5A shows an exhaust insulation system according to an example of the present disclosure.

FIG. 5B shows an exhaust insulation system in a stage of manufacture according to an example of the present disclosure.

FIG. 6 shows a flow diagram of a method of insulating an exhaust pipe according to an example of the present disclosure.

### DETAILED DESCRIPTION

In the following detailed description of the invention, reference is made to the accompanying drawings that form a part hereof and in which are shown, by way of illustration, specific embodiments in which the invention may be practiced. These embodiments are described in sufficient detail to enable those skilled in the art to practice the invention. Other embodiments may be utilized, and structural, logical, and electrical changes may be made.

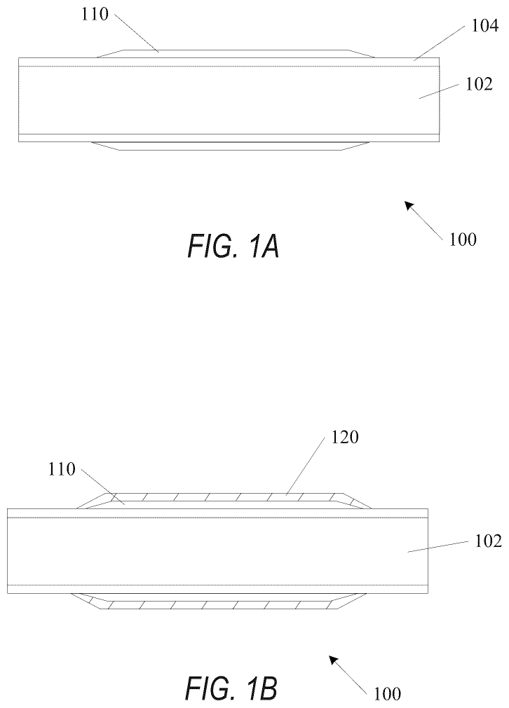

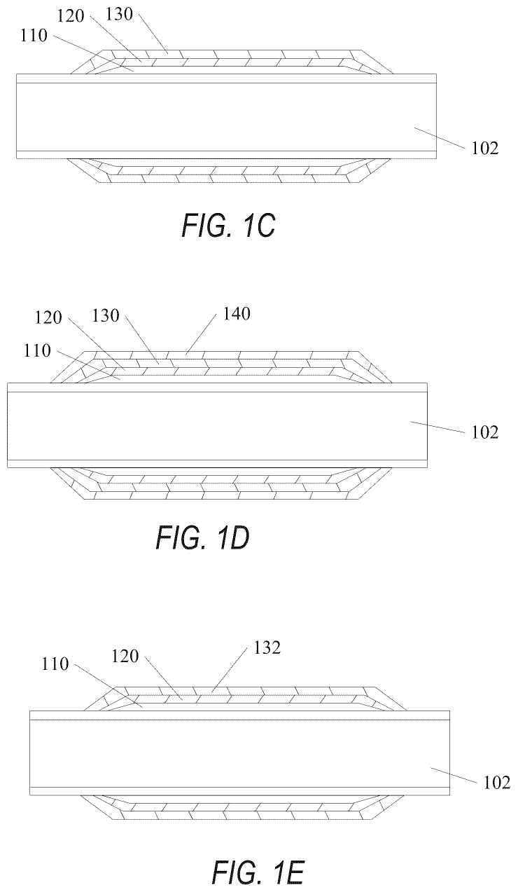

FIG. 1A shows an example of an exhaust insulation system 100 in a stage of manufacture. In the stage illustrated in FIG. 1A, an exhaust pipe section 102 is shown in cross section. A pipe wall 104 is illustrated. Although a pipe section 102 is used as an example, the invention is not so limited. Other geometries apart from tubular sections are within the scope of the present disclosure. Further, other exhaust system components are within the scope of the present disclosure. Examples of the present insulation system can be used to insulate any of a number of hot or cold components from adjacent components. As such, applications of the technology described can be used in applications apart from exhaust components.

In the stage of FIG. 1A, a base insulation layer 110 is located around a section of the pipe 102. In one example, the base insulation layer 110 includes a fiber mat insulation layer. Although a fiber mat is used as an example base insulation layer 110, the invention is not so limited. Other examples of base insulation layer 110 include woven fabrics, foams, meshes, etc. Although a glass fiber material is used as an example, other examples include, but are not limited to, alkaline earth silicate fibers, basalt fibers, carbon fibers, ceramic fibers, etc.

In FIG. 1B, a retaining layer 120 is shown over the base insulation layer 110. In one example, the retaining layer 120 includes a wrapped tape retaining layer. In the example of FIG. 1B, the retaining layer includes a spiral wrap, although the invention is not so limited. Other examples include a single sheet wrap or intermittent bands wrapped at selected intervals along the pipe 102. In selected examples no retaining layer 120 is used, as discussed in more detail in other examples below.

In the present disclosure, the term “tape” refers to a flat strip of material. In selected examples, the term “tape” refers to a component that may include an adhesive on one or more sides, although the invention is not so limited. Examples of tape described include non-adhesive backed components that are wrapped and may be secured in place using processes such as curing, or may use an adhesive, or both curing and an adhesive. Other securing mechanisms such as mechanical fasteners or bands are also possible. In examples below that describe uncured elastomer tape, one example configuration includes rolled or calendared elastomer material that is formed into strips.

In one example, the retaining layer 120 includes a polymer tape wrap. In one example the polymer tape wrap includes polyimide tape. In one example the polymer tape wrap includes polyester. In one example, a wrapped tape retaining layer compresses the base insulation layer 110 by a selected percentage. In examples that include compression of the base insulation layer 110, a thickness of the base insulation layer 110 is more effectively controlled than with a bare base insulation layer 110. For example, base insulation layer 110 may be compressed by about 40%-60% or more, depending on the application. In one example, the base insulation layer 110 has a thickness of about 0.75 inches when placed over an exhaust component and a thickness of 0.40 inches after being compressively wrapped by the retaining layer 120.

In selected examples, the retaining layer 120 includes a polymer tape without any adhesive that functions by wrapping and friction alone. In selected examples, the retaining layer 120 includes a polymer tape with an adhesive on one or more sides. In one example, an adhesive on the retaining layer 120 includes a silicone adhesive. Advantages of a silicone adhesive include the ability to resist breakdown or burning at high temperatures. In one example, the silicone adhesive resists breakdown or burning at temperatures exceeding 300° F. In one example, the silicone adhesive resists breakdown or burning at temperatures exceeding 400° F. Although silicone adhesive is advantageous and used as an example, the invention is not so limited. Other adhesives are also within the scope of the invention.

In FIG. 1C, the system 100 is wrapped with an uncured elastomer tape 130. In one example, the uncured elastomer tape 130 includes an uncured silicone tape. As discussed in more detail below, in one example, wrapping with the uncured elastomer tape 130 includes wrapping while applying an amount of tension on the uncured elastomer tape 130. The tension in the uncured elastomer tape 130 helps to conform the uncured elastomer tape 130 to any bends or shapes in the pipe 102. Tension applied when wrapping the uncured elastomer tape 130 also helps form solid contact surfaces with higher contact surface area between windings of the uncured elastomer tape 130 which will aid in final properties after curing. Improved contact between windings and increased contact surface area between windings results in a more complete, continuous cured elastomer layer 132 as indicated in FIG. 1E, after curing.

In FIG. 1D, the uncured elastomer tape 130 is further wrapped with an outer layer 140 and the uncured elastomer tape 130 is cured. In selected examples, the outer layer 140 is included before a curing operation of the uncured elastomer tape 130. In one example, wrapping with the outer layer 140 facilitates holding the uncured elastomer tape 130 for more complete curing and formation of the continuous cured elastomer layer 132. In one example the outer layer 140 is wrapped in tension to provide pressure to the uncured elastomer tape 130 and increase contact between windings of the uncured elastomer tape 130. As noted above, increased contact between windings provides more reaction surface area between windings of the uncured elastomer tape 130 and leads to a more complete, continuous cured elastomer layer 132.

In one example, curing includes crosslinking the uncured elastomer tape 130 to transform the uncured elastomer tape 130 into the continuous cured elastomer layer 132. In one example curing includes room temperature curing of the uncured elastomer tape 130. In one example curing includes applying heat for an amount of time to initiate a crosslinking chemical reaction that transforms the uncured elastomer tape 130 into the continuous cured elastomer layer 132. In one example, curing in two different temperature stages. In one example, curing includes a first cure stage within a temperature range between 200 degrees F. and 240 degrees F. In one example, curing includes a second cure stage after the first cure stage, within a temperature range between 265 degrees F. and 305 degrees F. In one example, curing includes a first cure stage at approximately 220 degrees F. and a second cure stage at approximately 285 degrees F.

In one example, the first cure stage includes a duration between 90 minutes and 150 minutes. In one example, the second cure stage includes a duration between 3 hours and 5 hours. In one example, the first cure stage is for approximately 2 hours, and the second cure stage is for approximately 4 hours.

In FIG. 1E, the outer layer 140 is removed, and the uncured elastomer tape 130 has transformed into the continuous cured elastomer layer 132. The continuous cured elastomer layer 132 includes a number of physical properties that result from the manufacture process described in FIGS. 1A-E. One physical property includes the continuous nature of the cured elastomer layer 132. Interfaces between windings are subsumed in the curing reaction process and what was originally a spiral wrap of tape becomes a continuous cylinder of cured elastomer. Another physical property of the continuous cured elastomer layer 132 includes a rounding of sharp edges, such as at edges of the uncured tape 130. Another physical property of the continuous cured elastomer layer 132 includes a removal of the residual tension in the uncured elastomer tape 130 that was present in the wrapping stage described above with respect to FIG. 1C.

Residual tension in a wrapped elastomer layer can lead to undesirable properties such as a tendency for a wrapped elastomer layer to peel away from the pipe 102 if scratched or cut. By starting with an uncured elastomer tape 130, then curing while under tension, any tension in the uncured elastomer tape 130 is relieved. A result is a continuous cured elastomer layer 132 without any residual tension from wrapping. In contrast, an elastomer tape that is wrapped while cured or partially cured will retain residual tension from wrapping. The residual tension in a tape that was wrapped while cured or partially cured will result in a final product that is more prone to damage from cuts or scratches, and is not completely continuous.

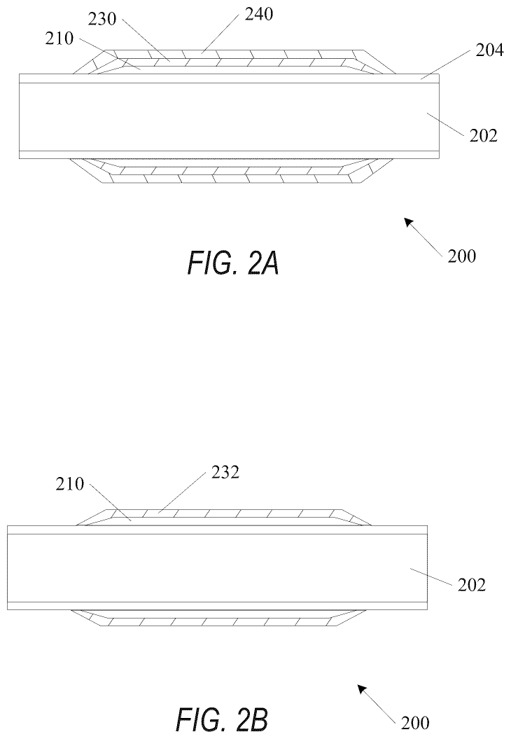

FIGS. 2A and 2B show another example of an exhaust insulation system 200 in stages of manufacture. In the example of FIGS. 2A and 2B, a retaining layer over the base insulation layer is not included.

FIG. 2A shows an exhaust pipe section 202 in cross section. A pipe wall 204 is illustrated. In the stage of FIG. 2A, a base insulation layer 210 is located around a section of the pipe 202. In one example, the base insulation layer 210 includes a fiber mat insulation layer. The base insulation layer 210 is wrapped with an uncured elastomer tape 230. In one example, the uncured elastomer tape 230 includes an uncured silicone elastomer tape.

In FIG. 2A, the uncured elastomer tape 230 is further wrapped with an outer layer 240 and the uncured elastomer tape 230 is cured. Similar to the examples of FIGS. 1A-1E, in selected examples, the outer layer 240 is included before a curing operation of the uncured elastomer tape 230. In one example, wrapping with the outer layer 240 facilitates holding the uncured elastomer tape 230 for more complete curing and formation of a continuous cured elastomer layer 232 as shown in FIG. 2B. In one example the outer layer 240 is wrapped in tension to provide pressure to the uncured elastomer tape 230 and increase contact between windings of the uncured elastomer tape 230. As noted above, increased contact between windings provides more reaction surface area between windings of the uncured elastomer tape 230 and leads to a more complete, continuous cured elastomer layer 232.

In FIG. 2B, the outer layer 240 is removed, and the uncured elastomer tape 230 has transformed into the continuous cured elastomer layer 232. Similar to the examples of FIGS. 1A-IE, the continuous cured elastomer layer 232 includes a number of distinguishable physical properties. One physical property includes the continuous nature of the cured elastomer layer 232. Interfaces between windings are subsumed in the curing reaction process and what was originally a spiral wrap of tape becomes a continuous cylinder of cured elastomer layer 232. Another physical property of the continuous cured elastomer layer 232 includes a rounding of sharp edges, such as at edges of the uncured tape 230. Another physical property of the continuous cured elastomer layer 232 includes a removal of any residual tension that was present in the uncured elastomer tape 230.

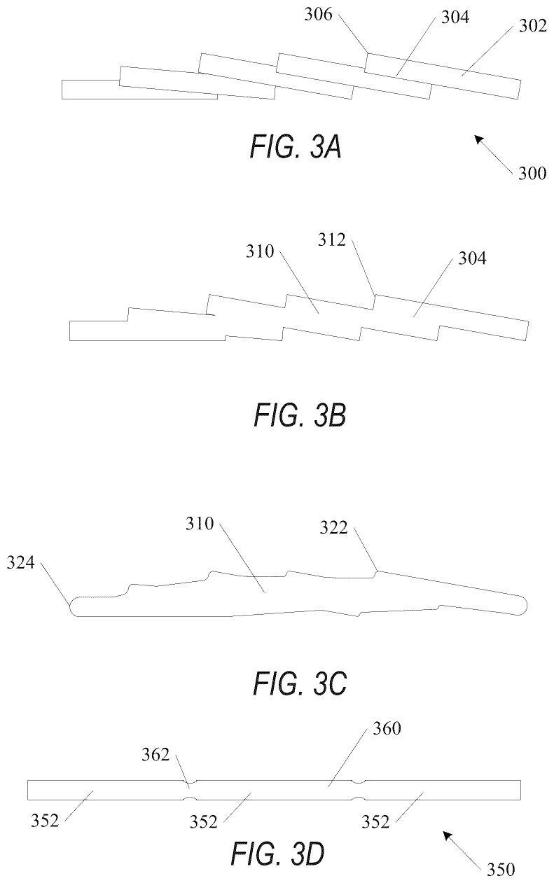

FIGS. 3A-3C illustrate examples of physical changes from a curing process of uncured elastomer tape windings. In FIG. 3A, a spiral wrap 300 is illustrated, including a number of individual windings 302 of uncured elastomer tape. In one example, the individual windings 302 include uncured silicone. FIG. 3A shows interfaces 304 between windings 302, and outward facing corners 306 of the windings 302. In the example of FIG. 3A, substantially all of the tape is uncured, in contrast to tape with a cured core, and uncured surface layer.

In FIG. 3B, after an amount of curing, the windings 302 begin to consolidate at the previous interfaces 304. In one example the uncured windings 302 begin to form crosslink connections in a bulk of the elastomer layer 232 and at the interfaces 304. This curing process results in a continuous elastomer 310 that retains much of the geometry of the original spiral wrap 300, however the curing process changes the windings into a single continuous elastomer 310. In FIG. 3B, outward facing corners 306 become ridges 312 in the single continuous elastomer 310.

In FIG. 3C, after addition curing, the continuous elastomer 310 exhibits additional physical features such as rounded corners 322 that were previously ridges 312 in the single continuous elastomer 310. Additionally, rounded ends 324 of the continuous elastomer 310 may form. In the example of FIG. 3C, the corners 322 remain in the continuous elastomer 310, and are visible as one or more spiral ridges that were converted from the windings 302 shown in FIG. 3A.

FIG. 3D shows another example of a spiral wrap 350 after curing as described above. The curing process changes windings 352 into a single continuous elastomer 360. In the example of FIG. 3D, the windings 352 are wound without overlapping one another. This is in contrast to overlapping interface 304 in the example of FIG. 3A. As a result, spiral seams 362 are formed, without any ridges such as ridges 312 from the example of FIG. 3B.

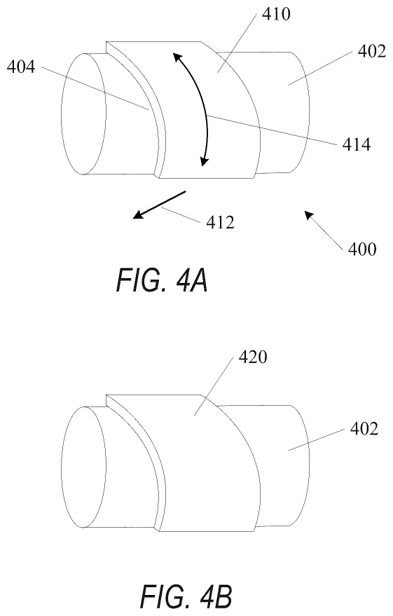

FIGS. 4A-4B illustrate additional examples of physical changes from a curing process of uncured elastomer tape windings. In FIG. 4A, an exhaust insulation system 400 is shown, An uncured elastomer tape 410 is wound over a section of a pipe 402. As it is wound, the tape 410 is pulled in direction 412. Friction of the tape 410 at interface 404 against the pipe 402 or against previous windings of the tape 410 provides resistance against the pulling in direction 412, and creates tensile stress within the tape 410. In FIG. 4A, residual tensile stress is indicated by arrows 414. When a pipe is wrapped with a tape that includes residual tensile stress, if the tape is nicked or cut, the residual stress will tend to increase a size of the nick or cut, as the residual tensile stress acts on sides of the nick or cut.

In examples of the present disclosure, the uncured elastomer tape 410 is cured after wrapping. Because substantially all of the uncured elastomer tape 410 is uncured, the curing process will allow any residual tensile stress to be removed during curing. If a portion of a tape is cured before wrapping the curing process will not affect the already cured portion, and residual tensile stress in the wrapped tape will remain after curing. In FIG. 4B, the residual tensile stress indicated by arrows 414 in the uncured elastomer tape 410 is removed in cured elastomer tape 420.

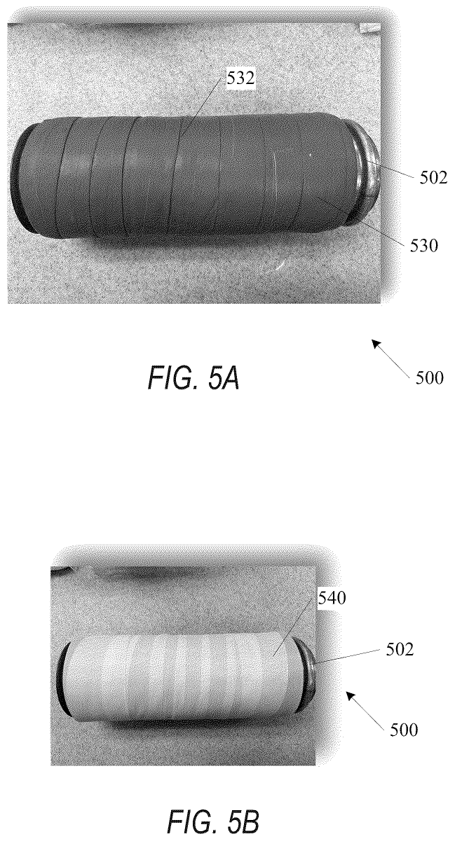

FIG. 5A shows a picture of an exhaust insulation system 500 according to an example of the present disclosure. The exhaust insulation system 500 includes a section of pipe 502, and a number of windings 530 of an uncured elastomer tape. One or more spiral ridges 532 are shown. In FIG. 5B, a retaining layer 540 is wrapped over the number of windings 530 of uncured elastomer tape. At the stage of manufacture shown in FIG. 5B, the exhaust insulation system 500 is cured, and the retaining layer 540 is removed after curing. The use of the retaining layer 540 during curing better facilitates large contact surface area between windings 530, and improves conversion of individual windings 530 into a continuous, stress relieved, elastomer layer. Although the retaining layer 540 is shown in FIG. 5B, other examples are included that do not utilize a retaining layer 540 during curing.

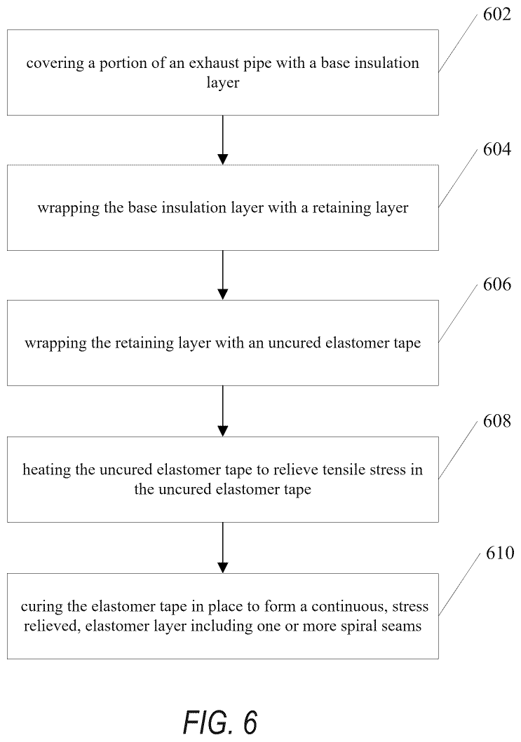

FIG. 6 shows one example of a flow diagram of a method of manufacture of an exhaust insulation system. In operation 602, a portion of an exhaust pipe is covered with a base insulation layer. In operation 604, the base insulation layer is wrapped with a retaining layer. In operation 606, the retaining layer is wrapped with an uncured elastomer tape. In operations 608 and 610, the uncured elastomer tape is cured to relieve tensile stress in the uncured elastomer tape, and the elastomer tape is cured in place to form a continuous, stress relieved, elastomer layer including one or more spiral seams.

To better illustrate the method and apparatuses disclosed herein, a non-limiting list of examples is provided here:

Aspect 1. A method of forming an exhaust insulation system, comprising: covering a portion of an exhaust pipe with a base insulation layer; wrapping the base insulation layer with a retaining layer; wrapping the retaining layer with an uncured elastomer tape; heating the uncured elastomer tape to relieve tensile stress in the uncured elastomer tape; and curing the elastomer tape in place to form a continuous, stress relieved, elastomer layer including one or more spiral seams.

Aspect 2. The method of aspect 1, wherein wrapping the retaining layer with the uncured elastomer tape includes wrapping with an amount of overlap and wherein the one or more spiral seams include one or more spiral ridges.

Aspect 3. The method of aspect 1, further including enclosing the uncured elastomer tape with an outer layer before heating to hold the uncured elastomer tape in place.

Aspect 4. The method of aspect 3, wherein enclosing the uncured elastomer tape with an outer layer includes wrapping with an overwrap tape.

Aspect 5. The method of aspect 4, further including removing the outer layer after curing the elastomer tape.

Aspect 6. The method of aspect 1, wherein covering the portion of the exhaust pipe with the base insulation layer includes covering with a glass fiber mat.

Aspect 7. The method of aspect 1, wherein covering the portion of the exhaust pipe with the base insulation layer includes covering with an alkaline earth silicate fiber mat.

Aspect 8. The method of aspect 1, wherein wrapping the retaining layer with an uncured elastomer tape includes wrapping with an uncured silicone tape, wherein substantially all of the silicone tape is uncured.

Aspect 9. The method of aspect 1, wherein wrapping the base insulation layer with a retaining layer includes wrapping with a polyimide tape.

Aspect 10. The method of aspect 1, wherein curing the elastomer tape includes curing in two different temperature stages.

Aspect 11. The method of aspect 10, wherein curing in two different temperature stages includes a first cure stage at approximately 220 degrees F. and a second cure stage at approximately 285 degrees F.

Aspect 12. The method of aspect 11, wherein the first cure stage is for approximately 2 hours, and the second cure stage is for approximately 4 hours.

Aspect 13. An exhaust insulation system for an exhaust pipe, comprising: a base insulation layer of an insulation disposed about a section of the exhaust pipe; and a continuous outer elastomer layer, the outer elastomer layer including; substantially no residual tensile stress; one or more exterior spiral seams in an integrally cured outer surface.

Aspect 14. The exhaust insulation system of aspect 13, wherein the one or more exterior spiral seams includes one or more spiral ridges.

Aspect 15. The exhaust insulation system of aspect 13, further including retaining layer between the base insulation layer and the continuous outer elastomer layer, the retaining layer at least partially surrounding the base insulation layer.

Aspect 16. The exhaust insulation system of aspect 15, wherein the retaining layer includes a polymer tape.

Aspect 17. The exhaust insulation system of aspect 15, wherein the retaining layer includes polyimide.

Aspect 18. The exhaust insulation system of aspect 15, wherein the retaining layer includes polyester.

Aspect 19. The exhaust insulation system of aspect 15, wherein the retaining layer is spirally wrapped.

Aspect 20. The exhaust insulation system of aspect 13, wherein the continuous outer elastomer layer includes silicone.

Aspect 21. The exhaust insulation system of aspect 13, wherein the base insulation layer includes a glass fiber mat.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method of forming an exhaust insulation system, comprising:
covering a portion of an exhaust pipe with a base insulation layer;
wrapping the base insulation layer with a retaining layer;
wrapping the retaining layer with an uncured elastomer tape;
heating the uncured elastomer tape to relieve tensile stress in the uncured elastomer tape; and
curing the elastomer tape in place to form a continuous, stress relieved, elastomer layer including one or more spiral seams.

2. The method of claim 1, wherein wrapping the retaining layer with the uncured elastomer tape includes wrapping with an amount of overlap and wherein the one or more spiral seams include one or more spiral ridges.

3. The method of claim 1, further including enclosing the uncured elastomer tape with an outer layer before heating to hold the uncured elastomer tape in place.

4. The method of claim 3, wherein enclosing the uncured elastomer tape with an outer layer includes wrapping with an overwrap tape.

5. The method of claim 4, further including removing the outer layer after curing the elastomer tape.

6. The method of claim 1, wherein covering the portion of the exhaust pipe with the base insulation layer includes covering with a glass fiber mat.

7. The method of claim 1, wherein covering the portion of the exhaust pipe with the base insulation layer includes covering with an alkaline earth silicate fiber mat.

8. The method of claim 1, wherein wrapping the retaining layer with an uncured elastomer tape includes wrapping with an uncured silicone tape, wherein substantially all of the silicone tape is uncured.

9. The method of claim 1, wherein wrapping the base insulation layer with a retaining layer includes wrapping with a polyimide tape.

10. The method of claim 1, wherein curing the elastomer tape includes curing in two different temperature stages.

11. The method of claim 10, wherein curing in two different temperature stages includes a first cure stage at approximately 220 degrees F. and a second cure stage at approximately 285 degrees F.

12. The method of claim 11, wherein the first cure stage is for approximately 2 hours, and the second cure stage is for approximately 4 hours.

13. An exhaust insulation system for an exhaust pipe, comprising:
a base insulation layer of an insulation disposed about a section of the exhaust pipe; and
a continuous outer elastomer layer, the outer elastomer layer including;
substantially no residual tensile stress;
one or more exterior spiral seams in an integrally cured outer surface.

14. The exhaust insulation system of claim 13, wherein the one or more exterior spiral seams includes one or more spiral ridges.

15. The exhaust insulation system of claim 13, further including retaining layer between the base insulation layer and the continuous outer elastomer layer, the retaining layer at least partially surrounding the base insulation layer.

16. The exhaust insulation system of claim 15, wherein the retaining layer includes a polymer tape.

17. The exhaust insulation system of claim 15, wherein the retaining layer includes polyimide.

18. The exhaust insulation system of claim 15, wherein the retaining layer includes polyester.

19. The exhaust insulation system of claim 15, wherein the retaining layer is spirally wrapped.

20. The exhaust insulation system of claim 13, wherein the continuous outer elastomer layer includes silicone.

21. The exhaust insulation system of claim 13, wherein the base insulation layer includes a glass fiber mat.
